(19) United States
(12) Patent Application Publication
(10) Pub. No.: US 2014/0159981 A1
(43) Pub. Date: Jun. 12, 2014

(54) PCB APPLIED TO WIRELESS TERMINAL AND WIRELESS TERMINAL

(71) Applicant: Huawei Device Co., Ltd., Shenzhen (CN)

(72) Inventor: Hanyang WANG, Shenzhen (CN)

(73) Assignee: Huawei Device Co., Ltd., Shenzhen (CN)

(21) Appl. No.: 14/143,896

(22) Filed: Dec. 30, 2013

Related U.S. Application Data
(63) Continuation-in-part of application No. PCT/CN2012/086154, filed on Dec. 7, 2012.

(51) Int. Cl. H01Q 1/52

(52) U.S. Cl. CPC H01Q 1/521
USPC 343/841

(57) ABSTRACT

Embodiments of the present disclosure provide a PCB connected to a wireless terminal and a wireless terminal. In the embodiments of the present disclosure, distribution of current on a PCB may be changed by resonance current that is generated by a resonant component included in the PCB, so that isolation between at least two antennas increases. In addition, due to existence of the resonance current, electromagnetic radiation capability of the PCB may be increased, so that radiation efficiency of each antenna increases, thereby improving wireless performance of the wireless terminal and effectively ensuring wireless performance of the wireless terminal in various application scenarios. Furthermore, the wireless terminal provided in the embodiment of the present disclosure is simple and easy to implement and has a low cost.

### CROSS-REFERENCE TO RELATED APPLICATIONS

This application is a continuation-in-part of International Patent Application No. PCT/CN2012/086154, filed on Dec. 7, 2012, which is hereby incorporated by reference in its entirety.

TECHNICAL FIELD

The present disclosure relates to communications technologies, and in particular, to a printed circuit board (PCB for short) applied to a wireless terminal and a wireless terminal.

### BACKGROUND

With rapid development of wireless communications technologies, a multi-antenna technology is more and more widely applied to various wireless terminals, such as a user equipment (UE) in a Long Term Evolution (LTE for short) system or a Worldwide Interoperability for Microwave Access (WIMAX for short) system. The multi-antenna technology means that multiple antennas are used both at a transmit end and at a receive end to send or receive a signal, that is, a multi-antenna system using the multi-antenna technology includes multiple transmit channels and multiple receive channels

However, because a spacing between multiple antennas of a wireless terminal is relatively small and operating frequency bands are overlapped, the multiple antennas affect each other, causing a decrease in isolation between at least two antennas and a decrease in radiation efficiency of each antenna, thereby lowering wireless performance of the wireless terminal.

### SUMMARY

In multiple aspects of the present disclosure, a PCB applied to a wireless terminal and a wireless terminal are provided to improve wireless performance of the wireless terminal.

In one aspect of the present disclosure, a PCB connected to a wireless terminal is provided, where the PCB includes a resonant component and the PCB is connected to at least two antennas of the wireless terminal by a part of the PCB other than the resonant component.

With reference to the foregoing aspect and any possible implementation manner, an implementation manner is further provided, where a first gap is formed on the PCB, the first gap splits the PCB into a first part and a second part, the second part is connected to the at least two antennas, the second part includes a metal ground, and the first part is connected to the metal ground of the second part, where, the resonant component is the first part, and a length of the first part is one fourth of an equivalent wavelength of a resonant frequency band of the resonant component; or the first part is connected to a conductor, the resonant component is the first part and the conductor, and a sum of lengths of the first part and the conductor is one fourth of an equivalent wavelength of a resonant frequency band of the resonant component.

With reference to the foregoing aspect and any possible implementation manner, an implementation manner is further provided, where an inductor is loaded on the first part, and the inductor is connected to the metal ground of the second part.

With reference to the foregoing aspect and any possible implementation manner, an implementation manner is further provided, where a second gap is formed on the PCB, the second gap splits the PCB into a third part and a fourth part, the fourth part is connected to the at least two antennas, the fourth part includes a metal ground, and the third part is connected to the metal ground of the fourth part, where a resonant network is loaded on the third part.

With reference to the foregoing aspect and any possible implementation manner, an implementation manner is further provided, where the resonant network is formed by a capacitor, or an inductor and a capacitor.

With reference to the foregoing aspect and any possible implementation manner, an implementation manner is further provided, where the PCB has a multi-layer structure;

a third gap is formed on a first-layer structure of the PCB, the third gap splits the first-layer structure into a fifth part and a sixth part, the sixth part is connected to the at least two antennas, the sixth part includes a metal ground, and the fifth part is connected to the metal ground of the sixth part;

a fourth gap is formed on a second-layer structure of the PCB, the fourth gap splits the second-layer structure into a seventh part and an eighth part, the eighth part is connected to the at least two antennas, the eighth part includes a metal ground, and the seventh part is connected to the metal ground of the eighth part; and

the fifth part and the seventh part have an overlap in a vertical direction of a plane on which the PCB resides.

In another aspect of the present disclosure, a wireless terminal is provided, including at least two antennas and the PCB applied to a wireless terminal according to the foregoing aspect and any possible implementation manner.

As can be seen from the foregoing technical solutions, in embodiments of the present disclosure, distribution of current on a PCB may be changed by resonance current that is generated by a resonant component included in the PCB, so that isolation between at least two antennas increases. In addition, due to existence of the resonance current, electromagnetic radiation capability of the PCB may be increased, so that radiation efficiency of each antenna increases, thereby improving wireless performance of a wireless terminal and effectively ensuring wireless performance of the wireless terminal in various application scenarios. Furthermore, the wireless terminal provided in the embodiments of the present disclosure is simple and easy to implement and has a low cost.

### BRIEF DESCRIPTION OF DRAWINGS

To illustrate the technical solutions in the embodiments of the present disclosure more clearly, the following briefly introduces the accompanying drawings required for describing the embodiments Apparently, the accompanying drawings in the following description show merely some embodiments of the present disclosure, and a person of ordinary skill in the art may still derive other drawings from these accompanying drawings without creative efforts.

FIG. 1 is a schematic structural view of a PCB applied to a wireless terminal according to an embodiment of the present disclosure;

FIG. 2 is a schematic structural view of a PCB applied to a wireless terminal according to another embodiment of the present disclosure;

FIG. 3 is a schematic structural view of a PCB applied to a wireless terminal according to another embodiment of the present disclosure;

FIG. 4 is a schematic structural view of a PCB applied to a wireless terminal according to another embodiment of the present disclosure;

FIG. 5A is a schematic structural view of a PCB applied to a wireless terminal according to another embodiment of the present disclosure;

FIG. 5B is a schematic partial enlarged view of a resonant network 130 according to the embodiment corresponding to FIG. 5A;

FIG. 6A is a schematic structural view of a PCB applied to a wireless terminal according to another embodiment of the present disclosure;

FIG. 6B is a schematic partial enlarged view of an overlap between a fifth part 15 and a seventh part 17 in a vertical direction of a plane on which a PCB 10 resides according to the embodiment corresponding to FIG. 6A;

FIG. 7A is a schematic graph of S parameters of each antenna of a wireless terminal using the PCB 10 that does not include a resonant component 30;

FIG. 7B is a schematic graph of S parameters of each antenna of a wireless terminal using the PCB 10 that includes a resonant component 30; and

FIG. 8 is a schematic graph of radiation efficiency of each antenna of the wireless terminal.

### DESCRIPTION OF EMBODIMENTS

To make the objectives, technical solutions, and advantages of the embodiments of the present disclosure more comprehensible, the following clearly describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

The wireless terminal according to an embodiment of the present disclosure may include but is not limited to a mobile phone, a data card, or a machine-to-machine (Machine to Machine, M2M for short) wireless module.

In addition, the term “and/or” in this specification is used only to describe an association relationship between associated objects and indicates that three relationships may exist. For example, “A and/or B” may indicate the following three cases: A separately exists, A and B simultaneously exist, and B separately exists. In addition, generally the symbol “/” in this specification indicates an “or” relationship between associated objects before and after the symbol.

The present disclosure provides a PCB connected to a wireless terminal and a wireless terminal, where: the wireless terminal may include a printed circuit board (Printed Circuit Board, PCB for short) and at least two antennas, the PCB includes a resonant component, and the PCB is connected to the at least two antennas by using a part of the PCB except for the resonant component. Since distribution of current on the PCB may be changed by resonance current that is generated by the resonant component, isolation between the at least two antennas increases. In addition, due to existence of the resonance current, electromagnetic radiation capability of the PCB may be increased, so that radiation efficiency of each antenna increases, thereby improving wireless performance of the wireless terminal and effectively ensuring wireless performance of the wireless terminal in various application scenarios. Furthermore, the wireless terminal provided in the embodiment of the present disclosure is simple and easy to implement and has a low cost.

Optionally, in a possible implementation manner of this embodiment, a first gap is formed on the PCB, the first gap splits the PCB into a first part and a second part, the second part is connected to the at least two antennas, the second part includes a metal ground, and the first part is connected to the metal ground of the second part.

Specifically, the resonant component may be the first part, and a length of the first part may be one fourth of an equivalent wavelength of a resonant frequency band of the resonant component.

Specifically, the first part may further be connected to a conductor, the resonant component may be the first part and the conductor, and a sum of lengths of the first part and the conductor may be one fourth of the equivalent wavelength of the resonant frequency band of the resonant component.

Optionally, an inductor may be further loaded on the first part, and the inductor is connected to the metal ground of the second part, so that the equivalent wavelength of the resonant frequency band of the resonant component may be shortened, thereby reducing the length of the first part or the sum of lengths of the first part and the conductor, and helping reduce the size.

Optionally, in a possible implementation manner of this embodiment, a second gap is formed on the PCB, the second gap splits the PCB into a third part and a fourth part, the fourth part is connected to the at least two antennas, the fourth part includes a metal ground, where a resonant network is loaded on the third part.

Specifically, the resonant network in this embodiment may be specifically a resonant circuit, and the resonant network may be formed by a capacitor C, or a combination of an inductor L and a capacitor C. That is, the resonant network in this embodiment may be implemented by a capacitor, or implemented by a combination of an inductor and a capacitor.

Optionally, in a possible implementation manner of this embodiment, the PCB may have a multi-layer structure; accordingly, a third gap is formed on a first-layer structure of the PCB, the third gap splits the first-layer structure into a fifth part and a sixth part, the sixth part is connected to the at least two antennas, and the sixth part includes a metal ground; a fourth gap is formed on a second-layer structure of the PCB, the fourth gap splits the second-layer structure into a seventh part and an eighth part, the eighth part is connected to the at least two antennas, and the eighth part includes a metal ground; and the fifth part and the seventh part have an overlap in a vertical direction of a plane on which the PCB resides.

It should be noted that the first-layer structure of the PCB and the second-layer structure of the PCB are structures of different layers, which may be structures of two adjacent layers or structures of two non-adjacent layers, and this is not limited herein in the present disclosure.

In the present disclosure, distribution of current on a PCB may be changed by resonance current that is generated by a resonant component included in the PCB, so that isolation between at least two antennas increases. In addition, due to existence of the resonance current, electromagnetic radiation capability of the PCB may be increased, so that radiation efficiency of each antenna increases, thereby improving wireless performance of a wireless terminal and effectively ensuring wireless performance of the wireless terminal in various application scenarios. Furthermore, the wireless terminal provided in the embodiment of the present disclosure is simple and easy to implement and has a low cost.

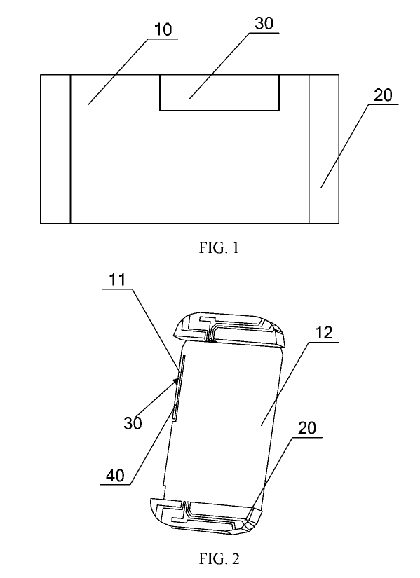

FIG. 1 is a schematic structural view of a PCB applied to a wireless terminal according to an embodiment of the present disclosure. As shown in FIG. 1, a wireless terminal may include a PCB 10 and at least two antennas 20, where the PCB 10 includes a resonant component 30 and the PCB 10 is connected to the at least two antennas 20 by using a part of the PCB 10 except for the resonant component 30.

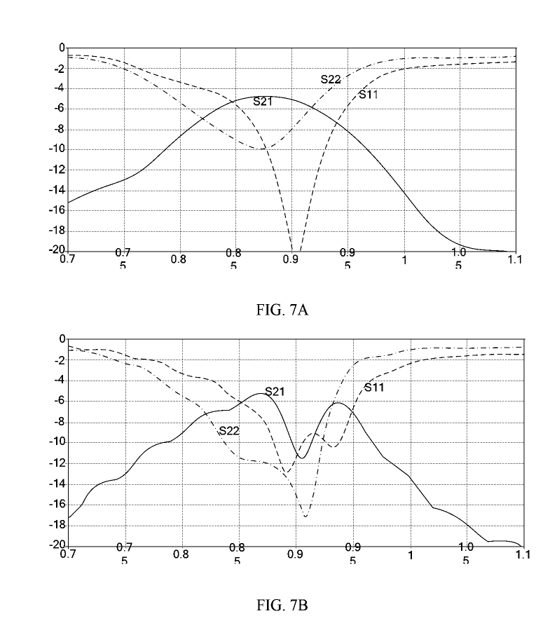

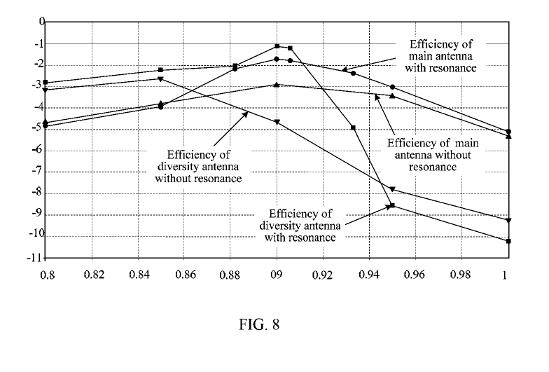

Since distribution of current on the PCB 10 may be changed by resonance current that is generated by the resonant component 30, isolation between the at least two antennas 20 increases. Taking a dual-antenna wireless terminal as an example, FIG. 7A is a schematic graph of scattering (Scattering, S) parameters of each antenna of the wireless terminal when the PCB 10 does not include the resonant component 30, and FIG. 7B is a schematic graph of S parameters of each antenna of the wireless terminal when the PCB 10 includes the resonant component 30. S11 indicates a reflection coefficient of an antenna port 1 when an antenna port 2 is matched; S22 indicates a reflection coefficient of the antenna port 2 when the antenna port 1 is matched; and S21 indicates a transmission coefficient from the antenna port 1 to the antenna port 2 when the antenna port 2 is matched. As can be seen, although isolation, that is, S21, increases, radiation efficiency, that is, S11, of the antenna is not obviously affected. Generally, a smaller S11 indicates less energy reflected back and more energy radiated outward. In this case, S11 may indicate that the radiation efficiency of the antenna is much higher. Therefore, generally S11 is used to roughly determine the radiation efficiency of the antenna.

In addition, due to existence of the resonance current, electromagnetic radiation capability of the PCB 10 may be increased, so that radiation efficiency of each antenna 20 increases, thereby improving wireless performance of the wireless terminal and effectively ensuring wireless performance of the wireless terminal in various application scenarios. Taking a dual-antenna wireless terminal as an example, FIG. 8 is a schematic graph of radiation efficiency of each antenna of the wireless terminal.

Furthermore, the wireless terminal provided in the embodiment of the present disclosure is simple and easy to implement and has a low cost.

Optionally, in a possible implementation manner of this embodiment, as shown in FIG. 2, a first gap 40 is formed on the PCB 10, the first gap 40 splits the PCB 10 into a first part 11 and a second part 12, the second part 12 is connected to the at least two antennas 20, the second part 12 includes a metal ground, and the first part 11 is connected to the metal ground of the second part 12.

Preferably, the first part 11 may be a strip structure at an edge of the PCB 10.

Specifically, the resonant component 30 may be the first part 11, and a length of the first part 11 may be one fourth of an equivalent wavelength of a resonant frequency band of the resonant component.

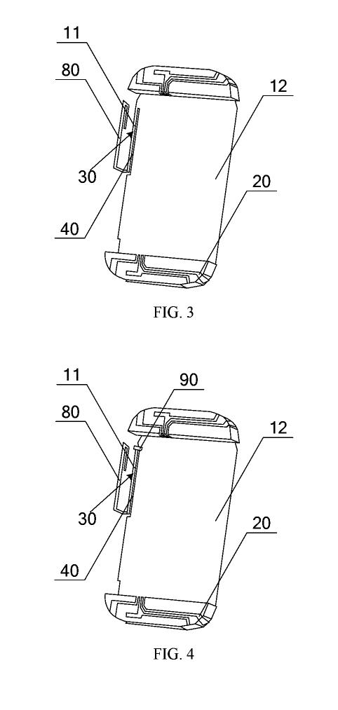

Specifically, as shown in FIG. 3, the first part 11 may further be connected to a conductor 80, the resonant component 30 may be the first part 11 and the conductor 80, and a sum of lengths of the first part 11 and the conductor 80 may be one fourth of the equivalent wavelength of the resonant frequency band of the resonant component.

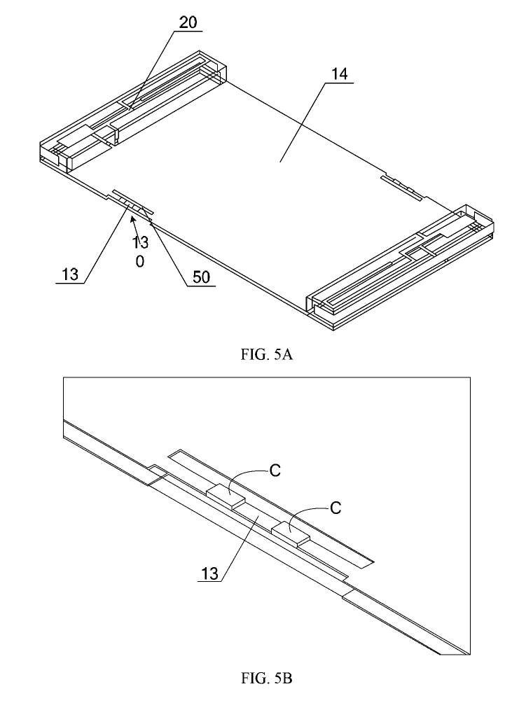

Optionally, as shown in FIG. 4, an inductor 90 may be further loaded on the first part 11, and the inductor 90 is connected to the metal ground of the second part 12, so that the equivalent wavelength of the resonant frequency band of the resonant component may be shortened, thereby reducing the length of the first part 11 or the sum of lengths of the first part 11 and the conductor 80, and helping reduce the size.

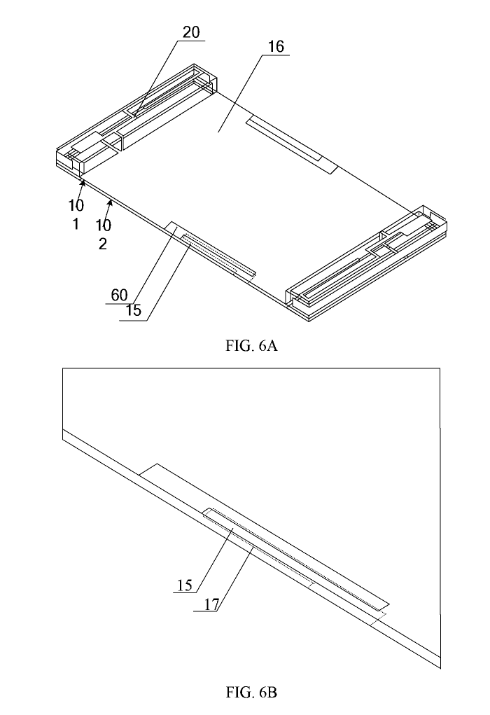

Optionally, in a possible implementation manner of this embodiment, as shown in FIG. 5A, a second gap 50 is formed on the PCB 10, the second gap 50 splits the PCB 10 into a third part 13 and a fourth part 14, the fourth part 14 is connected to the at least two antennas 20, the fourth part 14 includes a metal ground, where, a resonant network 130 is loaded on the third part 13.

Preferably, the third part 13 may be a strip structure at an edge of the PCB 10.

Specifically, the resonant network 130 in this embodiment may be specifically a resonant circuit, and the resonant network 130 may be formed by a capacitor C, or a combination of an inductor L and a capacitor C. That is, the resonant network 130 in this embodiment may be implemented by a capacitor, or implemented by a combination of an inductor and a capacitor. FIG. 5B is a schematic partial enlarged view of the resonant network 130.

Optionally, in a possible implementation manner of this embodiment, as shown in FIG. 6A, the PCB 10 may have a multi-layer structure; accordingly, a third gap 60 is formed on a first-layer structure 101 of the PCB 10, the third gap 60 splits the first-layer structure 101 into a fifth part 15 and a sixth part 16, the sixth part 16 is connected to the at least two antennas 20, and the sixth part 16 includes a metal ground; a fourth gap is formed on a second-layer structure 102 of the PCB 10, the fourth gap splits the second-layer structure 102 into a seventh part and an eighth part, the eighth part is connected to the at least two antennas 20, and the eighth part includes a metal ground; and the fifth part 15 and the seventh part have an overlap in a vertical direction of a plane on which the PCB 10 resides.

Since the fifth part 15 and the seventh part have an overlap in the vertical direction of the plane on which the PCB 10 resides, a capacitance effect can be formed. FIG. 6B is a schematic partial enlarged view of the overlap between the fifth part 15 and the seventh part 17 in the vertical direction of the plane on which the PCB 10 resides.

Preferably, the fifth part 15 and the seventh part may be respectively a strip structure at an edge of the first-layer structure 101 of the PCB 10 and a strip structure at an edge of the second-layer structure 102 of the PCB 10.

It should be noted that the first-layer structure 101 of the PCB 10 and the second-layer structure 102 of the PCB 10 are structures of different layers, which may be structures of two adjacent layers or structures of two non-adjacent layers, and this is not limited herein in the present disclosure.

In this embodiment, distribution of current on a PCB 10 may be changed by resonance current that is generated by a resonant component 30 included in the PCB 10, so that isolation between at least two antennas 20 increases. In addition, due to existence of the resonance current, electromagnetic radiation capability of the PCB 10 may be increased, so that radiation efficiency of each antenna 20 increases, thereby improving wireless performance of a wireless terminal and effectively ensuring wireless performance of the wireless terminal in various application scenarios. Furthermore, the wireless terminal provided in the embodiment of the present disclosure is simple and easy to implement and has a low cost.

Another embodiment of the present disclosure provides a wireless terminal, including at least two antennas and the PCB applied to a wireless terminal according to the embodiments corresponding to FIG. 1 to FIG. 8.

It should be noted that “first”, “second”, and the like in the embodiments are intended to differentiate each functional component rather than representing a sequence of components.

Finally, it should be noted that the foregoing embodiments are merely intended for describing the technical solutions of the present disclosure rather than limiting the present disclosure. Although the present disclosure is described in detail with reference to the foregoing embodiments, a person of ordinary skill in the art should understand that he may still make modifications to the technical solutions described in the foregoing embodiments, or make equivalent replacements to some technical features thereof, as long as such modifications or replacements do not cause the essence of corresponding technical solutions to depart from the spirit and scope of the technical solutions of the embodiments of the present disclosure.

What is claimed is:

1. A PCB connected to a wireless terminal, wherein the PCB comprises a resonant component and the PCB is connected to at least two antennas of the wireless terminal by a part of the PCB other than the resonant component.

2. The PCB connected to a wireless terminal according to claim 1, further including a first gap that splits the PCB into a first part and a second part, the second part is connected to the at least two antennas, the second part comprises a metal ground, and the first part is connected to the metal ground of the second part, wherein,
the resonant component is the first part, and a length of the first part is one fourth of an equivalent wavelength of a resonant frequency band of the resonant component; or
the first part is connected to a conductor, the resonant component is the first part, and a sum of lengths of the first part and the conductor is one fourth of an equivalent wavelength of a resonant frequency band of the resonant component.

3. The PCB connected to a wireless terminal according to claim 2, further including an inductor on the first part, and the inductor is connected to the metal ground of the second part.

4. The PCB connected to a wireless terminal according to claim 2, further including a second gap on the PCB, wherein the second gap splits the PCB into a third part and a fourth part, the fourth part is connected to the at least two antennas, the fourth part comprises a metal ground, and the third part is connected to the metal ground of the fourth part; and a resonant network on the third part.

5. The PCB connected to a wireless terminal according to claim 4, wherein the resonant network includes a capacitor, or an inductor and a capacitor.

6. The PCB connected to a wireless terminal according to claim 1, wherein the PCB has a multi-layer structure;
a third gap on a first-layer structure of the PCB, wherein the third gap splits the first-layer structure into a fifth part and a sixth part, the sixth part is connected to the at least two antennas, the sixth part comprises a metal ground, and the fifth part is connected to the metal ground of the sixth part;
a fourth gap on a second-layer structure of the PCB, wherein the fourth gap splits the second-layer structure into a seventh part and an eighth part, the eighth part is connected to the at least two antennas, the eighth part comprises a metal ground, and the seventh part is connected to the metal ground of the eighth part; and
the fifth part and the seventh part have an overlap in a vertical direction of a plane on which the PCB resides.

7. A wireless terminal, comprising at least two antennas and a PCB having a resonant component, wherein the PCB is connected to the at least two antennas by a part of the PCB other than the resonant component.

8. The wireless terminal of claim 7, wherein the PCB further includes a first gap that splits the PCB into a first part and a second part, the second part is connected to the at least two antennas, the second part comprises a metal ground, and the first part is connected to the metal ground of the second part, wherein,
the resonant component is the first part, and a length of the first part is one fourth of an equivalent wavelength of a resonant frequency band of the resonant component; or
the first part is connected to a conductor, the resonant component is the first part, and a sum of lengths of the first part and the conductor is one fourth of an equivalent wavelength of a resonant frequency band of the resonant component.

9. The wireless terminal of claim 8, wherein the PCB further includes an inductor on the first part, and the inductor is connected to the metal ground of the second part.

10. The wireless terminal of claim 8, wherein the PCB further includes a second gap on the PCB, wherein the second gap splits the PCB into a third part and a fourth part, the fourth part is connected to the at least two antennas, the fourth part comprises a metal ground, and the third part is connected to the metal ground of the fourth part; and a resonant network on the third part.

11. The wireless terminal of claim 10, wherein the resonant network includes a capacitor, or an inductor and a capacitor.

12. The wireless terminal of claim 7, wherein the PCB has a multi-layer structure;
a third gap on a first-layer structure of the PCB, wherein the third gap splits the first-layer structure into a fifth part and a sixth part, the sixth part is connected to the at least two antennas, the sixth part comprises a metal ground, and the fifth part is connected to the metal ground of the sixth part;
a fourth gap on a second-layer structure of the PCB, wherein the fourth gap splits the second-layer structure into a seventh part and an eighth part, the eighth part is connected to the at least two antennas, the eighth part comprises a metal ground, and the seventh part is connected to the metal ground of the eighth part; and
the fifth part and the seventh part have an overlap in a vertical direction of a plane on which the PCB resides.
